(19) United States
(12) Patent Application Publication
(10) Pub. No.: US 2007/0077513 A1
(43) Pub. Date: Apr. 5, 2007

(54) Positive-working lithographic printing plate precursor

(75) Inventors: Paola Campestrini, Mortsel (BE); Joan Vermeersch, Deinze (BE); Marc Van Damme, Bonheiden (BE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: AGFA-GEVAERT, Mortsel (BE)

(21) Appl. No.: 10/583,542

(22) PCT Filed: Dec. 8, 2004
(86) PCT No.: PCT/EP04/53329

§ 371 Date: Aug. 2, 2006

Related U.S. Application Data
(60) Provisional application No. 60/536,358, filed on Jan. 14, 2004.

(30) Foreign Application Priority Data
Dec. 18, 2003 (EP) 03104782.2

(51) Int. Cl. G03C 1/00

(52) U.S. Cl. 430/270.1

(57) ABSTRACT

A positive-working lithographic printing plate precursor is disclosed which comprises (i) a grained and anodized aluminum support having a hydrophilic surface and (ii) a heat-sensitive oleophilic coating provided on the hydrophilic surface, wherein said coating comprises (a) a hydrophobic polymer which is soluble in an aqueous alkaline developer and (b) a dissolution inhibitor which is a water-repellent polymer and wherein said coating is capable of dissolving in said developer at a higher dissolution rate in areas of said coating which are exposed to heat or infrared light than in unexposed areas, characterized in that the hydrophilic surface has a surface roughness, measured according to ISO 4288 and expressed as arithmetical mean center-line roughness Ra′, which is less than 0.40 μm and the hydrophilic surface comprises a salt of titanium, hafnium or zirconium. A hydrophilic surface, which has a low surface roughness and contains a salt of titanium, hafnium or zirconium, is used to obtain an improved sensitivity of the coating with a reduced staining and an increased printing run length.

### FIELD OF THE INVENTION

The present invention relates to a heat-sensitive positive-working lithographic printing plate precursor that requires aqueous alkaline processing.

### BACKGROUND OF THE INVENTION

Lithographic printing presses use a so-called printing master such as a printing plate which is mounted on a cylinder of the printing press. The master carries a lithographic image on its surface and a print is obtained by applying ink to said image and then transferring the ink from the master onto a receiver material, which is typically paper. In conventional lithographic printing, ink as well as an aqueous fountain solution (also called dampening liquid) are supplied to the lithographic image which consists of oleophilic (or hydrophobic, i.e. ink-accepting, water-repelling) areas as well as hydrophilic (or oleophobic, i.e. water-accepting, ink-repelling) areas. In so-called driographic printing, the lithographic image consists of ink-accepting and ink-abhesive (ink-repelling) areas and during driographic printing, only ink is supplied to the master.

Printing masters are generally obtained by the image-wise exposure and processing of an imaging material called plate precursor. A typical positive-working plate precursor comprises a hydrophilic support and an oleophilic coating which is not readily soluble in an aqueous alkaline developer in the non-exposed state and becomes soluble in the developer after exposure to radiation. In addition to the well known photosensitive imaging materials which are suitable for UV contact exposure through a film mask (the so-called pre-sensitized plates), also heat-sensitive printing plate precursors have become very popular. Such thermal materials offer the advantage of daylight stability and are especially used in the so-called computer-to-plate method wherein the plate precursor is directly exposed, i.e. without the use of a film mask. The material is exposed to heat or to infrared light and the generated heat triggers a (physico-)chemical process, such as ablation, polymerization, insolubilization by cross-linking of a polymer, heat-induced solubilization, or particle coagulation of a thermoplastic polymer latex. Examples of such thermal plates, wherein also the role of surface roughness of the aluminum support is discussed, are disclosed in U.S. Pat. No. 6,242,156 and EP-A 884 647.

EP 1 219 464 A2 discloses a lithographic printing plate precursor which comprises a metal support having formed thereon an anodic oxide film, and an image-forming layer containing a light-to-heat converting agent or a light-sensitive layer capable of image-forming with infrared laser exposure provided on the anodic oxide film.

EP 1 157 854 A2 discloses a presensitized plate which comprises an intermediate layer readily soluble in alkali, and a photosensitive layer that can become alkali-soluble by heating, said layers being sequently provided on a support for a lithographic printing plate, provided by subjecting an aluminum plate to graining treatment, alkali etching treatment and anodizing treatment. Herein, an amount of alkali etching is set in a range of 0.5 to 4 g/m² for said alkali etching treatment, and an average thickness of thinnest 10% of said photosensitive layer on convex portions of a surface of the support is set in a range of 0.2 to 2 μm.

U.S. Pat. No. 6,352,812 B1 discloses the preparation of a thermal lithographic printing plate comprising an aluminum as hydrophilic substrate. The average surface roughness of this substrate may range from an Ra-value of 0.1 to 0.8 μm.

EP-A 03 101 850.0, filed on 24 Jun. 2003, which constitutes prior art under A 54(3) EPC, discloses a positive-working lithographic printing plate precursor which comprises (i) a grained and anodized aluminum support having a hydrophilic surface and (ii) a heat-sensitive oleophilic coating provided on the hydrophilic surface. The heat-sensitive oleophilic coating is capable of being dissolved in an aqueous alkaline developer at a higher dissolution rate in areas of the coating which are exposed to heat or infrared light than in unexposed areas. The hydrophilic surface has a surface roughness, expressed as arithmetical mean center-line roughness Ra, which is less than 0.40 μm and this low surface roughness provides an improved shelf life of the heat-sensitive oleophilic coating.

A specific problem associated with thermal plate precursors is a limited sensitivity together with background stain in non-exposed area and a limited printing run length, especially when printed on a press under aggressive printing conditions.

### SUMMARY OF THE INVENTION

It is an aspect of the present invention to provide a positive-working thermal lithographic printing plate precursor with improved sensitivity on thermal recording.

In another aspect of the present invention, a positive-working thermal lithographic printing plate precursor is provided which exhibits a reduced level of background stain in the non-exposed area after alkaline developing.

In another aspect of the present invention, a positive-working thermal lithographic printing plate precursor is provided which exhibits an improved printing run length.

These objects are realized by the material of claim 1, having the characterizing features that the grained and anodized aluminum support has a low surface roughness and that the hydrophilic surface comprises a salt of titanium, hafnium or zirconium.

These objects are also realized by the method for making a positive-working lithographic printing plate precursor comprising the step as defined in claim 11.

These objects are also realized by the method for making a positive-working lithographic printing plate comprising the step as defined in claim 12.

Specific embodiments of the invention are defined in the dependent claims.

### DETAILED DESCRIPTION OF THE INVENTION

The support of the plate precursor of the present invention is a grained and anodized aluminum support having a hydrophilic surface that is characterized by a low surface roughness and by the presence of a salt of titanium, hafnium or zirconium.

The surface roughness is expressed as the arithmetical mean center-line roughness (Ra), sometimes also referred to as CLA (center-line average). Ra as used herein is defined in ISO 4287/1 (=DIN 4762) and references therein. Ra values reported herein have been measured according to ISO 4288 and references therein by a mechanical profile method using a contact stylus with a very thin tip (also optical profile methods are known; such optical methods systematically provide higher values than the ISO method). The apparatus used for measuring the Ra-values of the examples was a Talysurf 10 from Taylor Hobson Ltd.

In accordance with the present invention there is provided a positive-working lithographic printing plate precursor comprising (i) a grained and anodized aluminum support having a hydrophilic surface and (ii) a heat-sensitive oleophilic coating provided on the hydrophilic surface, wherein said coating comprises (a) a hydrophobic polymer which is soluble in an aqueous alkaline developer and (b) a dissolution inhibitor which is a water-repellent polymer and wherein said coating is capable of dissolving in said developer at a higher dissolution rate in areas of said coating which are exposed to heat or infrared light than in unexposed areas, characterized in that the hydrophilic surface has a surface roughness, measured according to ISO 4288 and expressed as arithmetical mean center-line roughness Ra, which is less than 0.40 μm and the hydrophilic surface comprises a salt of titanium, hafnium or zirconium. The Ra value of the hydrophilic surface of the grained and anodized aluminum support used in the material of the present invention is lower than 0.40 μm, preferably lower than 0.30 μm and even more preferably lower than 0.25 μm. A grained and anodized aluminum support having a hydrophilic surface characterized by the mentioned low Ra values is briefly referred to herein as a “smooth support”. The lower limit of the Ra value is preferably about 0.05 μm, more preferably about 0.1 μm.

Graining and anodizing of aluminum lithographic supports is well known. The grained aluminum support used in the material of the present invention is preferably an electrochemically grained support. The acid used for graining can be e.g. nitric acid. The acid used for graining preferably comprises hydrogen chloride. Also mixtures of e.g. hydrogen chloride and acetic acid can be used.

The relation between electrochemical graining and anodizing parameters such as electrode voltage, nature and concentration of the acid electrolyte or power consumption on the one hand and the obtained lithographic quality in terms of Ra and anodic weight (g/m² of Al₂O₃ formed on the aluminum surface) on the other hand is well known. More details about the relation between various production parameters and Ra or anodic weight can be found in e.g. the article “Management of Change in the Aluminium Printing Industry” by F. R. Mayers, to be published in the ATB Metallurgie Journal. So the skilled person is well aware of the settings of the various parameters which are required for making a smooth surface on a grained aluminum support or for making a given anodic weight during aluminum anodization. According to the present invention, further improvements can be obtained for a given roughness Ra by forming more than 3.0 g/m² of aluminum oxide at the hydrophilic surface, a value above 4.0 g/m² being even more preferred.

The grained and anodized aluminum support is further post-anodic treated with a compound comprising a salt of titanium, hafnium or zirconium, hereinafter also referred to as “PAT-compound”. Preferably, the post-anodic treatment is carried out with a compound comprising a salt of zirconium.

Typically, in the post-anodic treatment the grained and anodized aluminum support is brought into contact with a solution of a PAT-compound, hereinafter also referred to as “PAT-solution”. This PAT-solution may be brought into contact with the plate by several methods and in this post-anodic treatment process several parameters may be of importance: the type and concentration of the PAT-compound in the solution, the pH of the PAT-solution, the temperature and time of contact (dwell-time) of the PAT-solution with the plate, the coating technique used for contacting the PAT-solution with the plate.

The post-anodic treatment is preferably carried out by an aqueous PAT-solution, preferably containing from 0.01% to 10.0% (w/w) (more preferably from 0.05% to 1.5%) of said PAT-compound. The temperature is preferably in the range of 10° to 90° C. (more preferably of 40° to 80° C.) and the dwell time is preferably in the range of 0.1 second to 5 minutes (more preferably of 0.2 second to 30 seconds). The PAT-solution has a pH which preferably lies between 1 and 6, most preferably between 3.5 and 5.5. Various coating techniques may be employed for application of the PAT-solution, such as dip coating, spray coating, slot coating, reverse roll coating or electrochemical coating; most preferred, however, is spray coating. Single pass processes are also preferred since they facilitate the avoidance of contamination which could otherwise occur as a consequence of re-circulation of the solution.

Examples of PAT-compounds according to the present invention are compounds comprising salts of titanium, hafnium or zirconium. Said salts may include the metal either as the cation, for example in halide, sulphate or nitrate salts, or as part of a complexed anion. Examples of such salts are hafnium sulphate, zirconium phosphate, titanium nitrate, hafnium acetate, zirconium fluoride and titanium chloride. The more preferred examples are salts of titanium, hafnium or zirconium wherein the metal is present in a metal-complex anion, such as a chlorotitanate or fluorozirconate anion. The most preferred examples in this regard are the alkali metal fluorozirconates, particularly alkali hexafluorozirconate, more particularly potassium or sodium hexafluorozirconate.

Before, simultaneously with or after this post-anodic treatment with a PAT-compound, the support may be treated with an aqueous solution comprising an additional post-anodic treatment compound such as a silicate, e.g. sodium silicate, an orthophosphate, a hypophosphonate, a hypophosphate, a pyrophosphonate, a pyrophosphate, a phosphonate, a polyphosphonate, a metaphosphonate salts or derivates of them. In addition, the following compounds may also be used: alkali metal fluorophosphonates or difluorophosphonates, phosphosilicates and phosphoborates, all of which facilitate the controlled release of phosphate into the post-anodic treatment solution, and various organic materials such as the copolymer of acrylic acid and vinyl phosphonic acid may also be used. The additional post-anodic treatment is carried out preferably after the post-anodic treatment with a salt of titanium, zirconium or hafnium. The solution for this additional post-anodic treatment comprises preferably at least one orthophosphate salt of an alkali metal, more preferably an alkali dihydrogen orthophosphate, most preferably potassium dihydrogen orthophosphate. The concentration of the orthophosphate salt in the aqueous solution ranges preferably between 0.01% and 10.0% (w/w) (more preferably between 0.05% and 1.5%) and the solution has a pH which preferably lies between 3 and 7, most preferably around 4.5. This additional treatment is carried out at a temperature ranging preferably between 5° and 95° C. (more preferably between 40° and 95° C.) and with a dwell time ranging preferably between 0.05 second and 5 minutes (more preferably between 0.1 second and 1 minute). Various coating techniques may be employed for application of the orthophosphate salt of an alkali metal, such as dip coating, spray coating, slot coating, reverse roll coating or electrochemical coating; most preferred, however, is spray coating. Single pass processes are also preferred since they facilitate the avoidance of contamination which could otherwise occur as a consequence of re-circulation of the solution. More detailed descriptions of these treatments are given in GB-A-1 084 070, DE-A-4 423 140, DE-A-4 417 907, EP-A-659 909, EP-A-537 633, DE-A-4 001 466, EP-A-292 801, EP-A-291 760 and U.S. Pat. No. 4,458,005.

Specifically, the solution for a post-anodic treatment may also contain materials such as sequestering agents, tannin, sulphuric acid, fluorides and other additives which are known to improve the lithographic properties of a substrate, including various organic and inorganic polymeric materials.

The aluminum oxide surface may be rinsed with a solution comprising an organic acid and/or salt thereof, e.g. carboxylic acids, hydroxycarboxylic acids, sulfonic acids or phosphonic acids, or their salts, e.g. succinates, phosphates, phosphonates, sulfates, and sulfonates. A citric acid or citrate solution is preferred. This treatment may be carried out at room temperature or may be carried out at a slightly elevated temperature of about 30 to 50° C.

According to the present invention there is provided a method for making a positive-working lithographic printing plate precursor, said method comprising the steps of:
graining and anodizing an aluminum support,
treating said grained and anodized aluminum support with a solution comprising a salt of titanium, hafnium or zirconium,
applying on said treated aluminum support a heat-sensitive oleophilic coating,
   wherein said coating comprises (a) a hydrophobic polymer which is soluble in an aqueous alkaline developer and (b) a dissolution inhibitor which is a water-repellent polymer,
   wherein said coating is capable of dissolving in said developer at a higher dissolution rate in areas of said coating which are exposed to heat or infrared light than in unexposed areas,
   wherein the surface of said grained and anodized aluminum support is hydrophilic and has a surface roughness, expressed as arithmetical mean center-line roughness Ra, which is less than 0.40 μm

The coating provided on the support is heat-sensitive, thereby providing a plate precursor which can be handled in normal working lighting conditions (daylight, fluorescent light) for several hours. The coating preferably does not contain UV-sensitive compounds which have an absorption maximum in the wavelength range of 200 nm to 400 nm such as diazo compounds, photoacids, photoinitiators, quinone diazides, or sensitizers. Preferably the coating neither contains compounds which have an absorption maximum in the blue and green visible light wavelength range between 400 and 600 nm.

The coating may comprise one or more distinct layers. Besides the layers discussed hereafter, the coating may further comprise e.g. a “subbing” layer which improves the adhesion of the coating to the support, a covering layer which protects the coating against contamination or mechanical damage, and/or a light-to-heat conversion layer which comprises an infrared light absorbing compound.

The coating is positive-working and capable of heat-induced solubilization, i.e. the coating is resistant to the developer and ink-accepting in the non-exposed state and becomes soluble in the developer upon exposure to heat or infrared light to such an extent that the hydrophilic surface of the support is revealed thereby.

The coating comprises a hydrophobic polymer that is soluble in an aqueous alkaline developer. Preferred polymers are phenolic resins, e.g. novolac, resoles, polyvinyl phenols and carboxy-substituted polymers. Typical examples of such polymers are described in DE-A-4007428, DE-A-4027301 and DE-A-4445820. In addition, the coating may comprise polymers which improve the printing run length and/or the chemical resistance of the plate. Examples thereof are polymers comprising sulfonamido (—SO₂—NR—) or imido (—CO—NR—CO—) pendant groups, wherein R is hydrogen, optionally substituted alkyl or optionally substituted aryl, such as the polymers described in EP-A 894622, 901902, 933682 and WO99/63407.

Other preferred alkali-soluble polymeric binder is a phenolic resin wherein the phenyl group or the hydroxy group of the phenolic monomeric unit are chemically modified with an organic substituent. The phenolic resins which are chemically modified with an organic substituent may exhibit an increased chemical resistance against printing chemicals such as fountain solutions or press chemicals such as plate cleaners. Examples of such alkali-soluble phenolic resins, which are chemically modified with an organic substituent, are described in EP-A 0 934 822, EP-A 1 072 432, U.S. Pat. No. 5,641,608, EP-A 0 982 123, WO99/01795, EP-A 02 102 446, filed on 15 Oct. 2002, EP-A 02 102 444, filed on 15 Oct. 2002, EP-A 02 102 445, filed on 15 Oct. 2002, EP-A 02 102 443, filed on 15 Oct. 2002, EP-A 03 102 522, filed on 13 Aug, 2003.

The modified resins described in EP-A 02 102 446, filed on 15 Oct. 2002, are more preferred, specially those resins wherein the phenyl-group of the phenolic monomeric unit of said phenolic resin is substituted with an group having the structure —N═N-Q, wherein the —N═N— group is covalently bound to a carbon atom of the phenyl group and wherein Q is an aromatic group. Most preferred are the polymers wherein Q has the following formula (I) 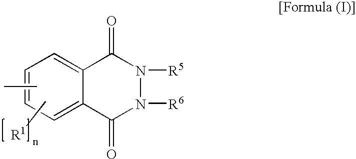
wherein n is 0, 1, 2 or 3,
wherein each R¹ is selected from hydrogen, an optionally substituted alkyl, alkenyl, alkynyl, cycloalkyl, heterocyclic, aryl, heteroaryl, aralkyl or heteroaralkyl group, —SO₂—NH—R², —NH—SO₂—R⁴, —CO—NR²—R³, —NR²—CO—R⁴, —O—CO—R⁴, —CO—O—R², —CO—R², —SO₃—R², —SO₂—R², —SO—R⁴, —P(=O)(—O—R²)(—O—R³), —NR²—R³, —O—R², —S—R², —CN, —NO₂, a halogen, -N-phthalimidyl, -M-N-phthalimidyl, or -M-R², wherein M represents a divalent linking group containing 1 to 8 carbon atoms,
wherein R², R³, R⁵ and R⁶ are independently selected from hydrogen or an optionally substituted alkyl, alkenyl, alkynyl, cycloalkyl, heterocyclic, aryl, heteroaryl, aralkyl or heteroaralkyl group,
wherein R⁴ is selected from an optionally substituted alkyl, alkenyl, alkynyl, cycloalkyl, heterocyclic, aryl, heteroaryl, aralkyl or heteroaralkyl group,
or wherein at least two groups selected from each R¹ to R⁴ together represent the necessary atoms to form a cyclic structure,
or wherein R⁵ and R⁶ together represent the necessary atoms to form a cyclic structure.

Other preferred alkali-soluble phenolic resins are phenolic resins wherein the phenyl-group of the phenolic monomeric unit or the hydroxy-group of the phenolic monomeric unit is substituted with a group having the structure of formula (I) as defined above.

The coating contains one or more dissolution inhibitors, i.e. one or more materials which reduce the dissolution rate of the hydrophobic polymer in the aqueous alkaline developer at the non-exposed areas of the coating. The dissolution inhibiting capability of the inhibitor can easily be tested by coating two samples on a support: a reference sample containing only the hydrophobic polymer and another including both the polymer (in equal amounts as the reference) as well as the inhibitor. A series of unexposed samples is immersed in an aqueous alkaline developer, each sample during a different time period. After the immersion period, the sample is removed from the developer, immediately rinsed with water, dried and then the dissolution of the coating in the developer is measured by comparing the weight of the sample before and after the development. As soon as the coating is dissolved completely, no more weight loss is measured upon longer immersion time periods, i.e. a curve representing weight loss as a function of immersion time reaches a plateau from the moment of complete dissolution of the layer. A material has good inhibiting capability when the coating of the sample without the inhibitor has dissolved completely in the developer before the sample with the inhibitor is attacked by the developer to such an extent that the ink-accepting capability of the coating is affected.

In accordance with the present invention, the coating comprises a dissolution inhibitor which is a water-repellent polymer. Such a polymer seems to increase the developer resistance of the coating by repelling the aqueous developer from the coating. The water-repellent polymer is added to the layer comprising the hydrophobic polymer and/or is present in a separate layer provided on top of the layer with the hydrophobic polymer. In the latter embodiment, the water-repellent polymer forms a barrier layer which shields the coating from the developer, and the solubility of the barrier layer in the developer or the penetrability of the barrier layer by the developer is increased by exposure to heat or infrared light, as described in e.g. EP-A 864420, EP-A 950517 and WO99/21725. Preferred examples of the water-repellent polymers are polymers comprising siloxane and/or perfluoroalkyl units. In one embodiment, the coating contains such a water-repellent polymer in an amount between 0.5 and 25 mg/m², preferably between 0.5 and 15 mg/m² and most preferably between 0.5 and 10 mg/m². When the water-repellent polymer is also ink-repelling, e.g. in the case of polysiloxanes, higher amounts than 25 mg/m² can result in poor ink-acceptance of the non-exposed areas. An amount lower than 0.5 mg/m² on the other hand may lead to an unsatisfactory development resistance. The polysiloxane may be a linear, cyclic or complex cross-linked polymer or copolymer. The term polysiloxane compound shall include any compound which contains more than one siloxane group —Si(R,R′)—O—, wherein R and R′ are optionally substituted alkyl or aryl groups. Preferred siloxanes are phenylalkylsiloxanes and dialkylsiloxanes. The number of siloxane groups in the (co)polymer is at least 2, preferably at least 10, more preferably at least 20. It may be less than 100, preferably less than 60. In another embodiment, the water-repellent polymer is a block-copolymer or a graft-copolymer of a poly(alkylene oxide) block and a block of a polymer comprising siloxane and/or perfluoroalkyl units. A suitable copolymer comprises about 15 to 25 siloxane units and 50 to 70 alkylene oxide groups. Preferred examples include copolymers comprising phenylmethylsiloxane and/or dimethylsiloxane as well as ethylene oxide and/or propylene oxide, such as Tego Glide 410, Tego Wet 265, Tego Protect 5001 or Silikophen P50/X, all commercially available from Tego Chemie, Essen, Germany. Such a copolymer acts as a surfactant which upon coating, due to its bifunctional structure, automatically positions itself at the interface between the coating and air and thereby forms a separate top layer even when the whole coating is applied from a single coating solution. Alternatively, the water-repellent polymer can be applied in a second solution, coated on top of the layer comprising the hydrophobic polymer. In that embodiment, it may be advantageous to use a solvent in the second coating solution that is not capable of dissolving the ingredients present in the first layer so that a highly concentrated water-repellent phase is obtained at the top of the coating.

In a preferred embodiment, other dissolution inhibitors can further added to the layer which comprises the alkali-soluble hydrophobic polymer discussed above. In this embodiment, the dissolution rate of the non-exposed coating in the developer is reduced by interaction between the hydrophobic polymer and the inhibitor, due to e.g. hydrogen bonding between these compounds. The dissolution inhibiting capability of the inhibitor is preferably reduced or destroyed by the heat generated during the exposure so that the coating readily dissolves in the developer at exposed areas. Such inhibitors are preferably organic compounds which comprise at least one aromatic group and a hydrogen bonding site, e.g. a carbonyl group, a sulfonyl group, or a nitrogen atom which may be quaternized and which may be part of a heterocyclic ring or which may be part of an amino substituent of said organic compound. Suitable dissolution inhibitors of this type have been disclosed in e.g. EP-A 825927 and 823327. Some of the compounds mentioned below, e.g. infrared dyes such as cyanines and contrast dyes such as quaternized triarylmethane dyes can also act as a dissolution inhibitor.

Preferably, also one or more development accelerators are included in the coating, i.e. compounds which act as dissolution promoters because they are capable of increasing the dissolution rate of the non-exposed coating in the developer, which can be tested by the same procedure as described above in relation to dissolution inhibitors. The simultaneous application of dissolution inhibitors and accelerators allows a precise fine tuning of the dissolution behavior of the coating. Suitable dissolution accelerators are cyclic acid anhydrides, phenols or organic acids. Examples of the cyclic acid anhydride include phthalic anhydride, tetrahydrophthalic anhydride, hexahydrophthalic anhydride, 3,6-endoxy-4-tetrahydrophthalic anhydride, tetrachlorophthalic anhydride, maleic anhydride, chloromaleic anhydride, alpha-phenylmaleic anhydride, succinic anhydride, and pyromellitic anhydride, as described in U.S. Pat. No. 4,115,128. Examples of the phenols include bisphenol A, p-nitrophenol, p-ethoxyphenol, 2,4,4′-trihydroxybenzophenone, 2,3,4-trihydroxy-benzophenone, 4-hydroxybenzophenone, 4,4′,4″-trihydroxy-triphenylmethane, and 4,4′,3″,4″-tetrahydroxy-3,5,3′,5′-tetramethyltriphenyl-methane, and the like. Examples of the organic acids include sulfonic acids, sulfinic acids, alkylsulfuric acids, phosphonic acids, phosphates, and carboxylic acids, as described in, for example, JP-A Nos. 60-88,942 and 2-96,755. Specific examples of these organic acids include p-toluenesulfonic acid, dodecylbenzenesulfonic acid, p-toluenesulfinic acid, ethylsulfuric acid, phenylphosphonic acid, phenylphosphinic acid, phenyl phosphate, diphenyl phosphate, benzoic acid, isophthalic acid, adipic acid, p-toluic acid, 3,4-dimethoxybenzoic acid, phthalic acid, terephthalic acid, 4-cyclohexene-1,2-dicarboxylic acid, erucic acid, lauric acid, n-undecanoic acid, and ascorbic acid. The amount of the cyclic acid anhydride, phenol, or organic acid contained in the coating is preferably in the range of 0.05 to 20% by weight, relative to the coating as a whole.

The material can be image-wise exposed directly with heat, e.g. by means of a thermal head, or indirectly by infrared light, which is preferably converted into heat by an infrared light absorbing compound, which may be a dye or pigment having an absorption maximum in the infrared wavelength range. The concentration of the sensitizing dye or pigment in the coating is typically between 0.25 and 10.0 wt. %, more preferably between 0.5 and 7.5 wt. % relative to the coating as a whole. Preferred IR-absorbing compounds are dyes such as cyanine or merocyanine dyes or pigments such as carbon black. A suitable compound is the following infrared dye:

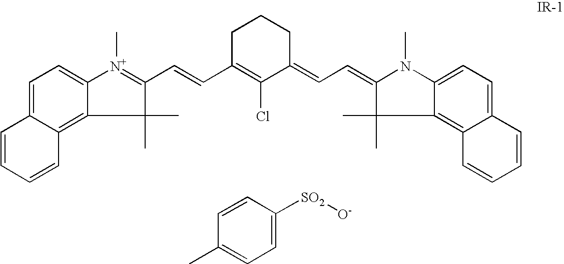

The coating may further contain an organic dye which absorbs visible light so that a perceptible image is obtained upon image-wise exposure and subsequent development. Such a dye is often called contrast dye or indicator dye. Preferably, the dye has a blue color and an absorption maximum in the wavelength range between 600 nm and 750 nm. Although the dye absorbs visible light, it preferably does not sensitize the printing plate precursor, i.e. the coating does not become more soluble in the developer upon exposure to visible light. Suitable examples of such a contrast dye are the quaternized triarylmethane dyes.

The infrared light absorbing compound and the contrast dye may be present in the layer comprising the hydrophobic polymer, and/or in the barrier layer discussed above and/or in an optional other layer. According to a highly preferred embodiment, the infrared light absorbing compound is concentrated in or near the barrier layer, e.g. in an intermediate layer between the layer comprising the hydrophobic polymer and the barrier layer.

The printing plate precursor of the present invention can be exposed to infrared light with LEDs or a laser. Preferably, a laser emitting near infrared light having a wavelength in the range from about 750 to about 1500 nm is used, such as a semiconductor laser diode, a Nd:YAG or a Nd:YLF laser. The required laser power depends on the sensitivity of the image-recording layer, the pixel dwell time of the laser beam, which is determined by the spot diameter (typical value of modern plate-setters at 1/e² of maximum intensity : 10-25 μm), the scan speed and the resolution of the exposure apparatus (i.e. the number of addressable pixels per unit of linear distance, often expressed in dots per inch or dpi; typical value: 1000-4000 dpi).

Two types of laser-exposure apparatuses are commonly used: internal (ITD) and external drum (XTD) plate-setters. ITD plate-setters for thermal plates are typically characterized by a very high scan speed up to 500 m/sec and may require a laser power of several Watts. XTD plate-setters for thermal plates having a typical laser power from about 200 mW to about 1 W operate at a lower scan speed, e.g. from 0.1 to 10 m/sec.

The known plate-setters can be used as an off-press exposure apparatus, which offers the benefit of reduced press down-time. XTD plate-setter configurations can also be used for on-press exposure, offering the benefit of immediate registration in a multi-color press. More technical details of on-press exposure apparatuses are described in e.g. U.S. Pat. No. 5,174,205 and U.S. Pat. No. 5,163,368.

In the development step, the non-image areas of the coating are removed by immersion in an aqueous alkaline developer, which may be combined with mechanical rubbing, e.g. by a rotating brush. The developer preferably has a pH above 10, more preferably above 12. The development step may be followed by a rinsing step, a gumming step, a drying step and/or a post-baking step.

The printing plate thus obtained can be used for conventional, so-called wet offset printing, in which ink and an aqueous dampening liquid is supplied to the plate. Another suitable printing method uses so-called single-fluid ink without a dampening liquid. Single-fluid ink consists of an ink phase, also called the hydrophobic or oleophilic phase, and a polar phase which replaces the aqueous dampening liquid that is used in conventional wet offset printing. Suitable examples of single-fluid inks have been described in U.S. Pat. No. 4,045,232; U.S. Pat. No. 4,981,517 and U.S. Pat. No. 6,140,392. In a most preferred embodiment, the single-fluid ink comprises an ink phase and a polyol phase as described in WO 00/32705.

### EXAMPLES

### Invention Examples 1 to 4 and Comparative Examples 1 to 6

Preparation of Lithographic Support S-01

A 0.30 mm thick aluminum foil AA1050, commercially available from ALCAN, was degreased by immersing the foil in an aqueous solution containing 34 g/l of sodium hydroxide at 70° C. for 6 seconds and rinsed with demineralized water for 2 seconds. The foil was then electrochemically grained using an alternating electric current in an aqueous solution containing 12 g/l of hydrochloric acid and 9 g/l of aluminum sulphate at a temperature of 37° C. and a current density of 105 A/dm². The aluminum foil was then rinsed with demineralized water and desmutted in an aqueous solution containing 145 g/l of sulfuric acid at 80° C. for 8 seconds. The grained aluminum foil was subsequently subjected to DC anodic oxidation in an aqueous solution containing 145 g/l of sulfuric acid at a temperature of 57° C., at a current density of 30 A/dm² to form an anodic oxidation film of 4.09 g/m² of Al₂O₃, measured by gravimetric experiments. The foil has a surface topography with an average center-line roughness Ra of 0.25 μm, measured with a TALYSURF 10 apparatus from TAYLOR HOBSON Ltd.

Post-Anodic Treatment (PAT) of Support S-01

The grained and anodized aluminum support S-01 was then treated by dipping a 24 cm×44 cm plate in a tank, containing different post-anodic treatment solutions and different post-anodic treatment conditions. The compound for the post-anodic treatment and the concentration of the compound in water, the temperature of the treatment and the dipping time are indicated in Table 1.

TABLE 1

| POST-ANODIC | | CONCENTRATION | TEMPERATURE | CONTACT- |
|---|---|---|---|---|
| TREATMENT | | of PAT-compound | of solution | TIME |
| (PAT) | COMPOUND | in water | for PAT | of PAT |
| number | for PAT | (g/l) | (° C.) | (sec.) |
| PAT-01 | K₂ZrF₆ | 4 | 45 | 20 |
| PAT-02 | K₂ZrF₆ | 4 | 65 | 15 |
| PAT-03 | K₂ZrF₆ | 4 | 65 | 20 |
| PAT-04 | KH₂PO₄ | 5 | 45 | 15 |
| PAT-05 | KH₂PO₄ | 5 | 65 | 15 |
| PAT-06 | KH₂PO₄ | 15 | 65 | 15 |
| PAT-07 | K₂ZrF₆ + KH₂PO₄ | 4 | 45 | 20 |
| | | 5 | 45 | 15 |
| PAT-08 | Polyvinyl- | 2.2 | 45 | 15 |
| | phosphonic acid | | | |
| PAT-09 | Polyvinyl- | 2.2 | 65 | 15 |
| | phosphonic acid | | | |
| PAT-10 | Polyvinyl- | 10 | 65 | 45 |
| | phosphonic acid | | | |

Preparation of Printing Plate Precursor

The printing plate precursors were produced by coating the solution defined in Table 2 onto the different post-anodic treated lithographic substrates as indicated in Table 1. The coating solution was applied at a wet coating thickness of 20 μm and then dried for 3 minutes at 130° C. The dry coating weight was 1.3 g/m².

TABLE 2
composition of the coating solution

| INGREDIENTS | Parts (grams) |
|---|---|
| Tetrahydrofuran | 82.30 |
| Alnovol SPN452 (1) | 67.10 |
| Dowanol PM (2) | 187.10 |
| Methyl ethyl ketone | 104.80 |
| S0094 (3) | 1.36 |
| 1 wt. % solution of Basonyl Blue 640 (4) in Dowanol PM | 34.45 |
| 1 wt. % solution of TegoGlide 410 (5) in Dowanol PM | 13.78 |
| 1 wt. % solution of TegoWet 265 (5) in Dowanol PM | 5.52 |
| 3,4,5-trimethoxy cinnamic acid | 3.47 |

(1) Alnovol SPN452 is a 40.5 wt. % solution of novolac in Dowanol PM (commercially available from Clariant).
(2) 1-methoxy-2-propanol from Dow Chemical Company.
(3) S0094 is an IR absorbing cyanine dye commercially available from FEW Chemicals. S0094 has the chemical structure IR-1 shown above.
(4) Basonyl Blue 640 is a quaternized triarylmethane dye commercially available from BASF.
(5) TegoWet 265 and TegoGlide 410 are both block-co-polysiloxane/poly(alkylene oxide) surfactants commercially available from Tego Chemie Service GmbH.

Exposure and Development

The printing plate precursors were then exposed with a CREO TRENDSETTER 3244 T, a plate-setter available from CREO, Burnaby, Canada, at 2450 dpi at different energy densities ranging from 80 mJ/cm² to 200 mJ/cm². After imaging, the plates were developed during 20 seconds in a TD6000 developing solution, available from AGFA-GEVAERT NV, at 25° C.

Sensitivity and Background Stain

The optical density of the image pattern (1×1 and 8×8 checkerboard) on the plates are measured with a GRETAG D19c-densitometer, using a cyan filter, for the different exposed energy densities. The sensitivity of the plate corresponds to the energy density where the optical densities of the two checkerboards match (or where the difference between these two optical densities is minimal). The lower the energy density, the higher the sensitivity of the plate precursor. (A sensitivity of >200 mJ/m² means that the difference between these two optical densities is substantial and that a higher exposing energy will be required.) The background stain is determined by the ratio of the optical density, measured with a GRETAG D19c-densitometer using a cyan filter, of a fully exposed area to a non-exposed area, i.e. ratio Dₘᵢₙ/Dₘₐₓ. The value of this ratio has to be as low as possible (or even a negative value), e.g. 0.0001 à 0.001, indicating no or very low background stain. Higher values indicate background stain and the higher the ratio the higher the stain, e.g. 0.002 à 0.01 means low stain, 0.02 à 0.1 means moderate stain, >0.1 means heavy stain. The results for these measurements for each plate are summarized in Table 3.

TABLE 3

| | | POST-ANODIC | | |
|---|---|---|---|---|
| EXAMPLE | SUPPORT | TREATMENT | SENSITIVITY | BACKGROUND STAIN |
| number | S-number | PAT-number | (mJ/m²) | (ratio Dₘᵢₙ/Dₘₐₓ) |
| Invention | S-01 | PAT-01 | 148 | 0.0001 |
| Example 1 | | | | |
| Invention | S-01 | PAT-02 | 118 | 0.0001 |
| Example 2 | | | | |
| Invention | S-01 | PAT-03 | 106 | 0.0001 |
| Example 3 | | | | |
| Comparative | S-01 | PAT-04 | >200 | 0.211 |
| Example 1 | | | | |
| Comparative | S-01 | PAT-05 | >200 | 0.181 |
| Example 2 | | | | |
| Comparative | S-01 | PAT-06 | >200 | 0.351 |
| Example 3 | | | | |
| Invention | S-01 | PAT-07 | 117 | 0.0001 |
| Example 4 | | | | |
| Comparative | S-01 | PAT-08 | 192 | 0.065 |
| Example 4 | | | | |
| Comparative | S-01 | PAT-09 | 160 | 0.015 |
| Example 5 | | | | |
| Comparative | S-01 | PAT-10 | 197 | 0.022 |
| Example 6 | | | | |

The Invention Examples 1 to 3 demonstrate that a positive-working printing plate precursor with a grained and anodized aluminum support, having a surface roughness Ra-value of 0.25 μm and an anodic weight of 4.09 g/m² and post-anodic treated with a hexafluorozirconate salt, exhibits an increased sensitivity without substantially background stain in the exposed area after alkaline development. The higher sensitivity and the absence of background stain are demonstrated for different concentrations of the hexafluorozirconate salt, at different temperatures and for different contact-times with the PAT-solution in comparison with other type of post-anodic treatment such as PAT with solutions of KH₂PO₄ or with solutions of polyvinyl phosphonic acid as demonstrated in the Comparative Examples 1 to 6. Invention Example 4 demonstrates an improved sensitivity without background stain for the combination of a post-anodic treatment with hexafluorozirconate and with KH₂PO₄.

### Invention Example 5

Preparation of Lithographic Support S-02

A 0.30 μm thick aluminum foil AA1050, commercially available from ALCAN, was degreased by immersing the foil in an aqueous solution containing 12 g/l of sodium hydroxide at 45° C. for 20 seconds and rinsed with demineralized water for 2 seconds. The foil was then electrochemically grained using an alternating electric current in an aqueous solution containing 9.5 g/l of hydrochloric acid and 18.5 g/l of acetic acid at a temperature of 26° C. and a charge density of 161.5 C/dm². The aluminum foil was then rinsed with demineralized water and desmutted in an aqueous solution containing 100 g/l of phosphoric acid at 41° C. for 20 seconds. The grained aluminum foil was subsequently subjected to DC anodic oxidation in an aqueous solution containing 135 g/l of sulfuric acid at a temperature of 45° C., at a charge density of 200 C/dm² to form an anodic oxidation film of 3.02 g/m² of Al₂O₃, measured by gravimetric experiments. The foil has a surface topography with an average center-line roughness Ra of 0.21 μm, measured with a TALYSURF 10 apparatus from TAYLOR HOBSON Ltd.

Post-Anodic Treatment PAT-11

The grained and anodized aluminum support S-02 was then post-anodic treated in a continuous line by dip coating of a solution of 4 g/l of K₂ZrF₆ at 46° C. during 20 seconds.

The preparation of printing plate precursor, the exposure and development of the plate, and the measuring of the sensitivity and background stain are carried out as described in the Invention Example 1.

For Invention Example 5, having an aluminum support S-02 and a PAT-11, a sensitivity value of 119 mJ/m² was obtained with a Dₘᵢₙ/Dₘₐₓ-ratio of 0.001, indicating a high sensitivity and a very low level of background stain.

### Invention Example 6

Preparation of Lithographic Support S-03

The preparation of the lithographic support S-03 was carried out in the same way as described in Invention Example 5 with the exception that the charge density in the electrochemically graining step of the aluminum foil was 300 C/dm² instead of 161.5 C/dm².

The foil has an anodic weight of 3.02 g/m² and a surface topography with an average center-line roughness Ra of 0.39 μm.

Post-Anodic Treatment PAT-12

The grained and anodized aluminum support S-03 was then post-anodic treated in a continuous line by dip coating of a solution of 4 g/l of K₂ZrF₆ at 46° C. during 20 seconds.

The preparation of printing plate precursor, the exposure and development of the plate, and the measuring of the sensitivity and background stain are carried out as described in the Invention Example 1.

For Invention Example 6, having an aluminum support S-03 and a PAT-12, a sensitivity value of 114 mJ/m²was obtained with a Dₘᵢₙ/Dₘₐₓ-ratio of 0.001, indicating a high sensitivity and a very low level of background stain.

### Invention Example 7 and Comparative Example 7

Preparation of Lithographic Support S-04 and S-05

The preparation of the lithographic support S-04 for the Invention Example 7 was carried out in the same way as described for S-01 with the exception that the current density in the anodic oxidation was 25 A/dm² instead of 30 A/dm². The foil has an anodic weight of 3.31 g/m² and a surface topography with an average center-line roughness Ra of 0.21 μm.

The lithographic support S-06 for the Comparative Example 7 is prepared in the same way as described for S-01. The foil has in this preparation an anodic weight of 4.00 g/m² and a surface topography with an average center-line roughness Ra of 0.21 μm.

Post-Anodic Treatment of S-05 and S-06

The support S-05 and S-06 are then post-anodic treated by spray coating as indicated in Table 4 by PAT-13 resp. PAT-14.

TABLE 4

| POST-ANODIC | | CONCENTRATION | TEMPERATURE | CONTACT- |
|---|---|---|---|---|
| TREATMENT | | of PAT-compound | of solution | TIME |
| (PAT) | COMPOUND | in water | for PAT | of PAT |
| number | for PAT | (g/l) | (° C.) | (sec.) |
| PAT-13 | K₂ZrF₆ | 5.5 | 80 | 6 |
| PAT-14 | Polyvinyl- | 2.2 | 70 | 6 |
| | phosphonic acid | | | |

Preparation of Printing Plate Precursor

The printing plate precursors were produced by coating the solution defined in Table 5 onto the different post-anodic treated lithographic substrates as indicated in Table 4. The coating solution was applied at a wet coating thickness of 26 μm and then dried for 3 minutes at 130° C.

TABLE 5
composition of the coating solution

| INGREDIENTS | Parts (grams) |
|---|---|
| Tetrahydrofuran | 205.00 |
| 20 wt. % solution of POL-01 (1) in Dowanol (2) | 238.59 |
| DURITE SD126A (3) | 15.84 |
| Dowanol PM (2) | 254.88 |
| Methyl ethyl ketone | 261.40 |
| S0094 (4) | 1.30 |
| 1 wt. % solution of TegoGlide 410 (5) in Dowanol PM | 21.69 |
| TOSPEARL 120 (6) | 1.30 |

(1) The synthesis of POL-01 is described in EP-A 02 102 446, filed on 15/10/2002, as “Polymer MP-22”.
(2) Dowanol PM is 1-methoxy-2-propanol from Dow Chemical Company.
(3) DURITE SD126A is a meta-cresol novolac resin obtained from BORDEN CHEM.INC. (Mₙ/M_{w} is 700/1700).
(4) S0094 is an IR absorbing cyanine dye commercially available from FEW Chemicals. S0094 has the chemical structure IR-1 shown above.
(5) TegoGlide 410 is a block-co-polysiloxane/poly(alkylene oxide) surfactants commercially available from Tego Chemie Service GmbH.
(6) TOSPEARL 120 is a cross-linked silicone particle with an average particle diameter of 2 μm, commercially available from TOSHIBA SILICONE Co., Ltd.

Exposure and Developing

The printing plate precursors were then exposed as described in the Invention Example 1. The image exposed on the plate precursor comprises a 50% screen of a 4×4 Checkerboard.

After imaging, the plates were developed in an AUTOLITH TP105-processor, available from AGFA-GEVAERT NV, operating at 25° C. and with a dwell-time of 22 seconds. The developing solution in the processor is composed of a mixture of 700 g demineralised water, 118 g sodium silicate, 0.134 g Supronic B25, commercially available from RODIA, 59.4 g sorbitol and 10 g Dowfax-2A1, commercially available from DOW, the mixture has a pH of about 13.2.

Printing

The plates, obtained after processing, were used as a printing master on a Heidelberg GTO52 printing press using K+E Skinnex Black, commercially available from BASF, as ink and Rotamatic, commercially available from Unigraphica GmbH, as fountain solution. The printing run length was evaluated by the quality of a 4×4 Checkerboard screen on the prints, i.e. the printing run length is denoted as the number of prints, wherein the 50% screen of the 4×4 checkerboard is rendered on the prints within a decrease of less than 5%. The results of the printing run length are summarized in Table 6.

TABLE 6

| | | POST-ANODIC | PRINTING RUN LENGTH |
|---|---|---|---|
| EXAMPLE | SUPPORT | TREATMENT | number of prints |
| number | S-number | PAT-number | (CHK4) |
| Invention | S-05 | PAT-13 | 102 000 |
| Example 7 | | | |
| Comparative | S-06 | PAT-14 | 54 000 |
| Example 7 | | | |

The Invention Example 7 demonstrates that a positive-working lithographic printing plate which comprises a smooth support, post-anodic treated with a solution of potassium hexafluoro zirconate, shows an improved printing run length on a sheet-fed printing press. The printing run length of the Comparative Example 7, wherein a smooth support is post-anodic treated with a polyvinylphosphonic acid shows an inferior run length.

### Invention Example 8 and Comparative Example 8

Preparation of Lithographic Support S-07 and S-08

The lithographic support S-07 for the Invention Example 8 is prepared in the same way as described for S-01. The foil has in this preparation an anodic weight of 4.04 g/m² and a surface topography with an average center-line roughness Ra of 0.24 μm.

The preparation of the lithographic support S-08 for the Comparative Example 8 was carried out in the same way as described for S-01 with the exception that the current density in the anodic oxidation was 22 A/dm² instead of 30 A/dm². The foil has an anodic weight of 2.93 g/m² and a surface topography with an average center-line roughness Ra of 0.21 μm.

Post-Anodic Treatment of S-07 and S-08

The support S-07 is then post-anodic treated in the same way as PAT-13 described in the Invention Example 7, and for support S-08 as PAT-14 described in the Comparative Example 7. The PAT-13 and PAT-14 are indicated in Table 4.

Preparation of Printing Plate Precursor

The printing plate precursors were produced by coating the solution defined in Table 7 onto the different post-anodic treated lithographic substrates. The coating solution was applied at a wet coating thickness of 26 μm and then dried for 3 minutes at 130° C.

TABLE 7
composition of the coating solution

| INGREDIENTS | Parts (grams) |
|---|---|
| Tetrahydrofuran | 205.56 |
| 20 wt. % solution of POL-01 (1) in Dowanol (2) | 242.35 |
| DURITE SD126A (3) | 14.05 |
| Dowanol PM (2) | 252.77 |
| Methyl ethyl ketone | 262.46 |
| S0094 (4) | 1.65 |
| 1 wt. % solution of TegoGlide 410 (5) in Dowanol PM | 21.69 |

(1) The synthesis of POL-01 is described in EP-A 02 102 446, filed on 15/10/2002, as “Polymer MP-22”.
(2) Dowanol PM is 1-methoxy-2-propanol from Dow Chemical Company.
(3) DURITE SD126A is a meta-cresol novolac resin obtained from BORDEN CHEM.INC. (Mₙ/M_{w} is 700/1700).
(4) S0094 is an IR absorbing cyanine dye commercially available from FEW Chemicals. S0094 has the chemical structure IR-1 shown above.
(5) TegoGlide 410 is a block-co-polysiloxane/poly(alkylene oxide) surfactants commercially available from Tego Chemie Service GmbH.

Exposure and Developing

The printing plate precursors were then exposed as described in the Invention Example 7 with the exception that the image exposed on the plate precursor comprises a 40% screen at 200 lpi.

After imaging, the plates were developed as described in Invention Example 7 with the exception that the developing solution in the processor is composed of a mixture of 700 g demineralised water, 120 g sodium silicate, 0.135 g Supronic B25, commercially available from RODIA and 46.33 g sorbitol, the mixture has a pH of about 13.25.

Printing

The plates, obtained after processing, were used as a printing master on a DRENT GAZELLE F480 web printing press from DRENT (The Netherlands), using Black Coldset WB18010 92BC14, commercially available from SUN Chemicals, as ink and an aqueous solution of 2% Fount-405 and 10% isopropanol as fountain solution, and ALSAWEB 45 g/m², commercially available from Papeteries Matussiere & Forest (France), as printing paper. The printing run length was evaluated on the quality of a 40% screen at 200 lpi on the prints, i.e. the printing run length is denoted as the number of prints, wherein the 40% screen at 200 lpi is not deteriorated visually. The results of the printing run length are summarized in Table 8.

TABLE 8

| | | POST-ANODIC | PRINTING RUN LENGTH |
|---|---|---|---|
| EXAMPLE | SUPPORT | TREATMENT | number of prints |
| number | S-number | PAT-number | (40% screen @ 200 lpi) |
| Invention | S-07 | PAT-13 | 110 000 |
| Example 8 | | | |
| Comparative | S-08 | PAT-14 | 50 000 |
| Example 8 | | | |

The Invention Example 8 demonstrates that a positive-working lithographic printing plate which comprises a smooth support, post-anodic treated with a solution of potassium hexafluoro zirconate, shows an improved printing run length on a web printing press. The printing run length of the Comparative Example 8, wherein a smooth support is post-anodic treated with a polyvinylphosphonic acid shows an inferior run length.

1. A positive-working lithographic printing plate precursor comprising (i) a grained and anodized aluminum support having a hydrophilic surface and (ii) a heat-sensitive oleophilic coating provided on the hydrophilic surface, wherein said coating comprises (a) a hydrophobic polymer which is soluble in an aqueous alkaline developer and (b) a dissolution inhibitor which is a water-repellent polymer and wherein said coating is capable of dissolving in said developer at a higher dissolution rate in areas of said coating which are expose to heat or infrared light than in unexposed areas, wherein the hydrophilic surface has a surface roughness, measured according to ISO 4288 and expressed as arithmetical mean center-line roughness Ra, which is less than 0.40 μm, and wherein the hydrophilic surface comprises a salt of titanium, hafnium or zirconium.

2. A plate precursor according to claim 1, wherein said salt comprises fluoride.

3. A plate precursor according to claim 1, wherein said hydrophilic surface further comprises an orthophosphate.

4. A plate precursor according to claim 1, wherein said hydrophilic surface has a surface roughness, expressed as arithmetical mean center-line roughness Ra, which is less than 0.3 μm.

5. A plate precursor according to claim 1, wherein said aluminum support comprises more than 3.0 g/m² of aluminum oxide at the hydrophilic surface.

6. A plate precursor according to claim 1, wherein said aluminum support comprises more than 4.0 g/m² of aluminum oxide at the hydrophilic surface.

7. A plate precursor according to claim 1, wherein said water-repellent polymer is
a polymer comprising siloxane and/or perfluoroalkyl units; or
a block- or graft-copolymer of a poly(alkylene oxide) block and a block comprising siloxane and/or perfluoroalkyl units.

8. A plate precursor according to claim 1, wherein said water-repellent polymer is present in a separate layer on top of said coating.

9. A plate precursor according to claim 1, wherein said coating further comprises another dissolution inhibitor which is an organic compound comprising an aromatic group and a hydrogen bonding site.

10. A plate precursor according to claim 1, wherein said coating further comprises a dissolution accelerator.

11. A method of making a positive-working lithographic printing plate precursor comprising the steps of
graining and anodizing an aluminum support,
treating said grained and anodized aluminum support with a solution comprising a salt of titanium, hafnium and zirconium, and
applying on said treated aluminum support a heat-sensitive oleophilic coating, wherein said coating comprises (a) a hydrophobic polymer which is soluble in an aqueous alkaline developer and (b) a dissolution inhibitor which is a water-repellent polymer, wherein said coating is capable of dissolving in said developer at a higher dissolution rate in areas of said coating which are exposed to heat or infrared light than in unexposed areas, and wherein the surface of said grained and anodized aluminum support is hydrophilic and has a surface roughness, measured according to ISO 4288 and expressed as arithmetical mean center-line roughness Ra, which is less than 0.40 μm.

12. A method of making a positive-working lithographic printing plate comprising the steps of
providing a positive-working lithographic printing plate precursor according to claim 1,
image-wise exposing said heat-sensitive coating to infrared light or heat, and
developing said image-wise exposed heat-sensitive coating with an aqueous alkaline developer, wherein the exposed areas of said coating dissolve in said alkaline developer at a higher dissolution rate than in unexposed areas of said coating.

13. (canceled)
